(19) United States
(12) Patent Application Publication
(10) Pub. No.: US 2021/0089972 A1
(43) Pub. Date: Mar. 25, 2021

(54) System and Method for Computer Based Transit Time Determination for Matching Geographically Separated Entities

(71) Applicants: Jubarko Gaines, Oklahoma City, OK (US); Anauta Gaines, Oklahoma City, OK (US)

(72) Inventors: Jubarko Gaines, Oklahoma City, OK (US); Anauta Gaines, Oklahoma City, OK (US)

(21) Appl. No.: 16/577,341

(22) Filed: Sep. 20, 2019

(51) Int. Cl. G06Q 10/02; G06Q 50/10; G01C 21/34

(52) U.S. Cl. CPC G06Q 10/02; G01C 21/3446; G06Q 50/10

(57) ABSTRACT

Methods and systems are disclosed for computer-based matching of geographically separated entities utilizing automated transit time determinations. One disclosed method comprises receiving, from one or more service-provider computer device, an availability status of a plurality of service providers; receiving, from a requester smartphone, a query from a service user comprising a request for available service providers; automatically determining transit time between the service user and each available service provider based on current location data associated with the requester smartphone, location data associated with each service provider, and mapping information; determining matching service provider(s) from the plurality of available service providers, based at least on the determined transit time between the service user and each service provider being a shorter duration than a predetermined-transit-time threshold; and providing, to the requester smartphone, the matching service providers.

### BACKGROUND

Historically, transit time-based determinations have not been used to match geographically separated entities by availability. For example, in the service industry, each entity is independently responsible for the determination of their own transit-time to a location in which a service is to be performed, and no consideration is given to the other entity's transit time. This arrangement may be acceptable for appointments established well in advance, or when the geographical separation between the entities is substantially small. In those cases, both entities need only to ensure they are available at the service location at the time when the service is to be performed. However, as the length of time between the establishment of the appointment and the actual appointment become shorter, the transit-time between geographically separated entities becomes more significant.

For example, traditionally, a person seeking the services of a barber or a hairstylist either establishes an appointment in advance or arrives at a barbershop/salon without the appointment and waits for the next available barber/hairstylist. In either instance, the service provider's geographical location remains constant, while the person receiving the service is the only one that must consider how long it will take them to travel to the barbershop/salon.

In some respects, an appointment-based customer may be more desirable because the barber/hairstylist would know precisely when they are slated to provide services, and they would be able to organize their schedule to maximize efficiency. In fact, some barbers/hairstylist will only accept customers that schedule an appointment weeks or even months in advance. However, even if the barber/hairstylist only accepts appointment-based customers, it is inevitable that some appointments will be canceled, leaving the barber/hairstylist at the barbershop/salon with a gap until the next scheduled appointment.

Alternatively, a large number of barbers/hairstylists still allow “walk-ins,” wherein a customer simply walks into the barbershop/salon and waits for the next available barber/hairstylist. Walk-ins may serve as gap-fillers between previously scheduled appointments, or they may be the primary customer base of the barber/hairstylist. Because the barber/hairstylist does not know when or even if a walk-in will occur, the barber/hairstylist may be waiting at the barbershop/salon for long periods of time without a customer.

From the perspective of the person receiving the services, scheduling an appointment for a haircut in advance allows the person to select a specific barber/hairstylist at a convenient time which helps the person to plan and organize other activities. However, there may be occasions in which a person is unable to schedule an appointment. For instance, the person may have to cancel a scheduled appointment due to an emergency, but still needs a haircut before a new appointment can be scheduled. In some cases, the uncertainty of a customer's personal schedule may not allow the booking of an appointment. While other people simply prefer not to make an appointment, and would rather seek the services of a barber/hairstylist at their convenience.

The concept of enabling a person to book an appointment with a barber/hairstylist in order to provide a haircut is well-known in the industry. Many services, data structures, and software applications are currently available to assist service providers and service recipients with the appointment booking process. However, the current systems do not allow a person to book an immediate appointment with a service provider based on the person's ability to arrive at the appointment within an acceptable wait time for the service provider.

What is needed is an automated method and system to provide a list of immediately available service providers within a predetermined range based on transit time from the potential customer's current location to the service provider's location and then allow the potential customer to schedule an immediate appointment with the service provider from the provided list.

### BRIEF DESCRIPTION OF THE SEVERAL VIEWS OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale, or in schematic in the interest of clarity and conciseness. Not every component may be labeled in every drawing. Like reference numerals in the figures may represent and refer to the same or similar element or function. In the drawings:

FIG. 1 is a block diagram of a computer system for including a transit-time determination for matching geographically separated entities in accordance with the present disclosure;

FIG. 2 is a flow chart of an exemplary embodiment of the process according to the present disclosure;

FIG. 3 is an exemplary screenshot of a display on a first or second user computer device, the screenshot depicting logging into the system;

FIG. 4 is an exemplary screenshot of a display on a first user computer device, the screenshot depicting selecting and updating a status of availability;

FIG. 5 is an exemplary screenshot of a display on a second user computer device, the screenshot depicting selecting and sending a first request for a list of available entities;

FIG. 6 is an exemplary screenshot of a display on a second user computer device, the screenshot depicting a list of available entities based on transit-time;

FIG. 7 is an exemplary screenshot of a display on a second user computer device, the screenshot depicting selecting and sending a second request for an entity;

FIG. 8 is an exemplary screenshot of a display on a first user computer device, the screenshot depicting the second request for the entity and an ability to respond the second request for the entity;

FIG. 9 is an exemplary screenshot of a display on a second user computer device, the screenshot depicting the response to the second request;

FIG. 10 is an exemplary screenshot of a display on a first or second user computer device, the screenshot depicting a map including a path from the second user computer device to the location of the first user computer device.

### DETAILED DESCRIPTION

Before explaining at least one embodiment of the inventive concept disclosed herein in detail, it is to be understood that the inventive concept is not limited in its application to the details of construction and the arrangement of the components or steps or methodologies set forth in the following description or illustrated in the drawings. The inventive concept disclosed herein is capable of other embodiments or of being practiced or carried out in various ways. Also, it is to be understood that the phraseology and terminology employed herein is for the purpose of description and should not be regarded as limiting in any way.

In the following detailed description of embodiments of the inventive concept, numerous specific details are set forth in order to provide a more thorough understanding of the inventive concept. It will be apparent to one of ordinary skill in the art, however, that the inventive concept within the disclosure may be practiced without these specific details. In other instances, well-known features have not been described in detail to avoid unnecessarily complicating the instant disclosure.

As used herein, the terms “network-based”, “cloud-based”, and any variations thereof, are intended to include the provision of configurable computational resources on demand via interfacing with a computer and/or computer network, with software and/or data at least partially located on the computer and/or computer network, by pooling processing power of two or more networked processors.

As used herein, the term “real time” means within one second, five seconds, fifteen seconds, thirty seconds, one minute, within two minutes, or within three minutes.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more and the singular also includes the plural unless it is obvious that it is meant otherwise.

Further, use of the term “plurality” is meant to convey “more than one” unless expressly stated to the contrary.

As used herein, qualifiers like “substantially,” “about,” “approximately,” and combinations and variations thereof, are intended to include not only the exact amount or value that they qualify, but also some slight deviations therefrom, which may be due to manufacturing tolerances, measurement error, wear and tear, stresses exerted on various parts, and combinations thereof, for example.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

The use of the term “at least one” or “one or more” will be understood to include one as well as any quantity more than one. In addition, the use of the phrase “at least one of X, V, and Z” will be understood to include X alone, V alone, and Z alone, as well as any combination of X, V, and Z.

The use of ordinal number terminology (i.e., “first”, “second”, “third”, “fourth”, etc.) is solely for the purpose of differentiating between two or more items and, unless explicitly stated otherwise, is not meant to imply any sequence or order or importance to one item over another or any order of addition.

As used in the instant disclosure, the terms “provide”, “providing”, and variations thereof comprise displaying or providing for display a software application (e.g., scheduling application) to one or more user terminals interfacing with a computer and/or computer network(s) and/or allowing the one or more user terminal(s) to participate, such as by interacting with one or more mechanisms on a webpage (e.g., scheduling application) by sending and/or receiving signals (e.g., digital, optical, and/or the like) via a computer network interface (e.g., Ethernet port, TCP/IP port, optical port, cable modem, and combinations thereof). A user may be provided with a web page in a web browser, or in a software application, for example.

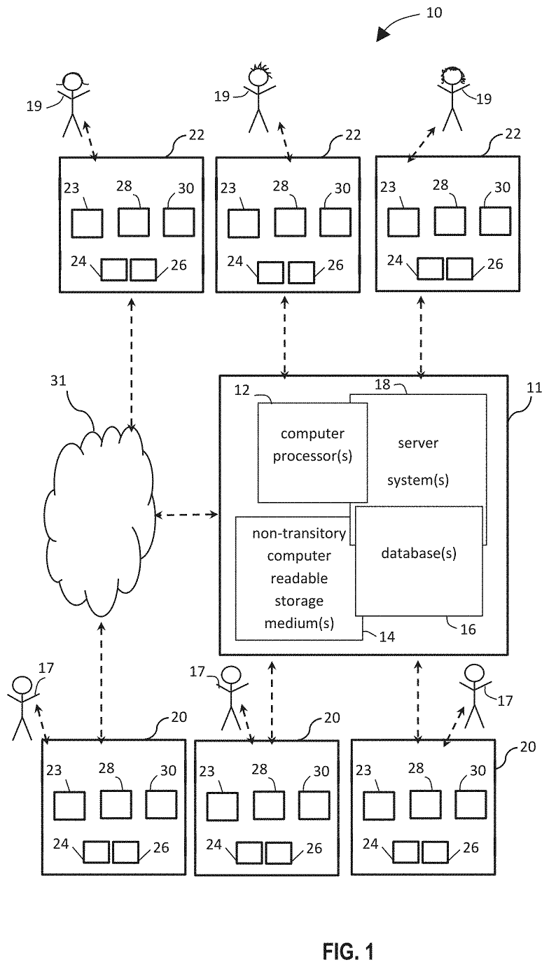

Referring now to the drawings, FIG. 1 is a block diagram of an exemplary computer-based matching system 10 that is constructed in accordance with the present disclosure for generating a transit time determination to match geographically separated entities by availability. The entities may be people, such as service providers/users or product providers/users, although other types of entities may be considered by the computer-based matching system 10. In one exemplary embodiment, the computer-based matching system 10 may be adapted to match a person with a plurality of service providers within an acceptable proximity based on transit time to a service location. In an alternative exemplary embodiment, the computer-based matching system 10 may be adapted to match a person with a product within an acceptable proximity based on transit time to a location of the product.

The computer-based matching system 10 may comprise a computer system 11, a plurality of first user computer devices 20, and a plurality of second user computer devices 22. In one embodiment, the computer-based matching system 10 may further comprise a network 31.

The computer system 11 may comprise one or more processor 12, one or more non-transitory computer-readable storage medium 14, and one or more database 16. The one or more processor 12, the one or more non-transitory computer-readable storage medium 14, and the one or more database 16 may or may not be located in a single physical location or in a single housing.

In one embodiment, the computer-based matching system 10 may further comprise a server system 18 having one or more servers in a configuration suitable to provide a commercial computer-based business system such as a commercial website and/or data center. One or more of the non-transitory computer-readable storage medium(s) 14, the processor(s) 12, or the database(s) 16 may be within the one or more server system 18.

The one or more processor 12 may be circuitry and/or a combination of hardware and software.

In one embodiment, the one or more non-transitory computer-readable storage medium 14 stores program logic, for example, a set of instructions capable of being executed by the one or more processor 12, that when executed by the one or more processor 12 causes the one or more processor 12 to carry out instructions for matching geographically separated entities based on availability and transit time between the entities. Exemplary non-transitory computer-readable storage medium 14 may include random access memory, read only memory, flash memory, and/or the like. Such non-transitory computer readable mediums may be electrically based, magnetically based, optically based, and/or the like.

The one or more database 16 may store a plurality of user profiles, a plurality of activity logs, a status of availability for a plurality of entities, and/or other data. Though it will be understood that the plurality of user profiles, the plurality of activity logs, and the status of availability for the plurality of entities may be provided from outside sources and/or stored elsewhere.

The plurality of first user computer devices 20 may be associated with a corresponding plurality of first entities 17 providing a service (service providers) or a product (product providers). The plurality of first entities 17 may comprise individuals and/or businesses.

The plurality of second user computer devices 22 may be associated with a corresponding plurality of second entities 19 seeking a service (service user) or a product (product user), which in general may referred to herein as “the requester”. The plurality of second entities 19 typically comprises individuals.

Each of the plurality of first and second user computer devices 20, 22 may comprise one or more positioning device 23, one or more input device 24, one or more transceiver device 26, one or more display 28, and one or more processor 30. The components of the first or second user computer devices 20, 22 may or may not be located in a single physical location or in a single housing. Nonexclusive examples of the first and second user computer devices 20, 22 may include a smartphone, a laptop computer, a tablet computer, a desktop computer, a kiosk-based computer, a wearable computer, and a vehicle-based computer.

The positioning device 23 may be configured to collect location data indicative of geospatial locations of the plurality of first and second user computer devices 20, 22. Non-exclusive examples of the position device 23 include a Global Positioning System (GPS), an internet-based location position determination system, and a cellular phone network-based position determination system.

The plurality of first and second user computer devices 20, 22 may be configured to receive information from the first entities 17 and the second entities 19, respectively, through the one or more input devices 24. The one or more input devices 24 may include, but are not limited to, implementation as one or more of: a keyboard, a touchscreen, a mouse, a trackball, a microphone, a fingerprint reader, an infrared port, a slide-out keyboard, a flip-out keyboard, a video game controller, a remote control, a fax machine, a network interface, a speech recognition device, a gesture recognition device, an eye tracking device, a brain-computer interface, combinations thereof, and/or the like.

The plurality of first and second user computer devices 20, 22 may be capable of outputting information, including information from the first entities 17 and the second entities 19, respectively, through the one or more transceiver devices 26. The one or more transceiver devices 26 may include, but are not limited to, implementations as a wireless receiver/transmitter or a wired receiver/transmitter or combinations thereof.

Nonexclusive examples of the one or more display 28 may include a screen, a projector capable of projecting information onto a surface or as a holograph, and heads-up devices (for example, eyeglasses or headgear).

The computer-based matching system 10 may bi-directionally and directly communicate with the plurality of first and second user computer devices 20, 22 and/or may bi-directionally communicate with the plurality of first and second user computer devices 20, 22 via a network 31. In one embodiment, the network 31 is the Internet and the plurality of first and second user computer devices 20, 22 interfaces with the computer system 11 via a series of web pages. It should be noted, however, that the network 31 may be almost any type of network and may be implemented as the World Wide Web (or Internet), a local area network (LAN), a wide area network (WAN), a metropolitan network, a wireless network, a cellular network, a Global System for Mobile Communications (GSM) network, a code division multiple access (CDMA) network, a 3G network, a 4G network, a 5G network, a satellite network, a radio network, an optical network, a cable network, a public switched telephone network, an Ethernet network, combinations thereof, and/or the like. It is conceivable that in the near future, embodiments of the present disclosure may use more advanced networking topologies.

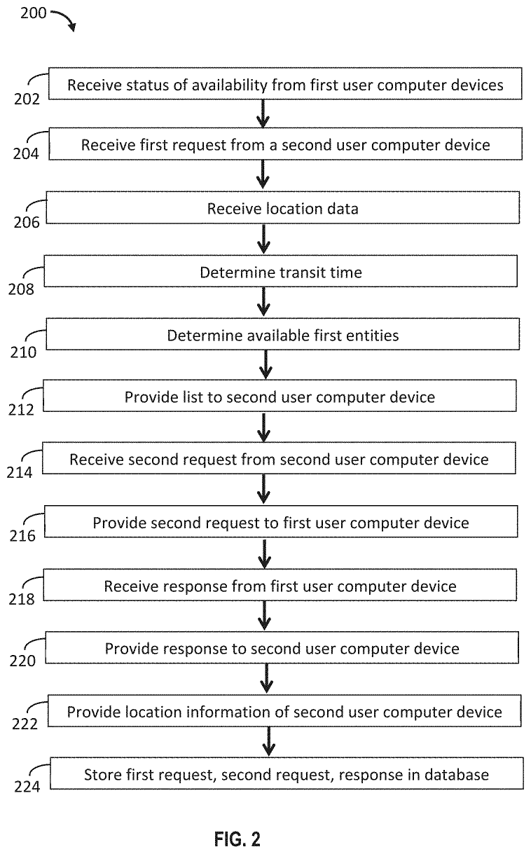

FIG. 2 is a process flow chart depicting an exemplary embodiment of a computer-based matching method 200 for transit time determination to match geographically separated entities by availability.

Generally, the computer-based matching method 200 comprises receiving, by the computer system 11, a status of availability of the first entities 17 associated with corresponding first user computer devices 20 from the plurality of first user computer devices 20 (step 202); receiving, by the computer system 11, a first request from a second user computer device 22 (step 204) of a second entity 19 indicative of a query about the availability of one or more first entities 17; receiving, with the processor of the computer system 11, location data associated with the plurality of first user computer devices 20 and the second user computer device 22 (step 206); automatically determining, with the one or more processor 12 of the computer system 11, transit times between each of the plurality of first user computer devices 20 and the second user computer device 22 based on the received location data (step 208); determining, with the computer system 11, available first entities 17 (step 210); and providing, with the computer system 11, information regarding matching available first entities 17 to the second user computer device 22 (step 212) for the second entity.

The status of availability of the first entities 17 is determined by the first entities 17 and indicates that whether each of the first entities 17 is available (such as to provide a service or product) or unavailable. The status of availability may be changed by the first entities 17. The status of availability may be referred to as an availability status.

The location data associated with the plurality of the first user computer devices 20 and the second user computer device 22 may be provided by the position devices 23 of the first and second user computer devices 20, 22. The location data may be provided by the first entities 17 and/or the second entities 19. The location data may be geospatial locations. Non-exclusive examples of position data include Global Positioning System (GPS) coordinates, latitude/longitude, latitude/longitude/elevation, street address, and location within a building (for example, floor number, room number, etc.). Location data associated with the plurality of the first user computer devices 20 may be referred to as first entity locations. Location data associated with the second user computer device 22 may be referred to as a second entity location.

The step 208 of automatically determining, with the one or more processor 12 of the computer system 11, transit times between each of the plurality of first user computer devices 20 and the second user computer device 22 based on the received location data may comprise generating, with the one or more processor 12, one or more routes between the second user computer device 22 and each of the plurality of first user computer devices 20 based on the received location data and mapping information. The one or more processor 12 may then determine the corresponding transit time with respect to each of the one or more routes. The determination may be based on one or more of the following: modality of travel, route of travel, local traffic laws, road conditions, environmental conditions, time of day, historical traffic data, real-time traffic reports, and any other variable that may affect the transit time. Modality of travel comprises the mode which the second user utilizes to travel to the first user location. Nonexclusive examples of modality of travel include walking, driving, bicycling, and using public transit.

In one embodiment, the step 208 of automatically determining, with the one or more processor 12 of the computer system 11, transit times between each of the plurality of first user computer devices 20 and the second user computer device 22 based on the received location data may further comprise calculating the transit time to each available service provider and/or receiving the transit time to each available service provider from one or more external sources. For example, the one or more processor 12 of the computer system 11 may receive the transit time(s) from a mapping software application.

The step 210 of determining available first entities 17 may be based on the status of availability received from the plurality of first user computer devices 20 and the calculated transit time. A particular first entity 17 may be included within the list of available first entities 17 if an “available” status was received from the first user computer device 20, and if the calculated transit time is determined to be a shorter duration than a predetermined transit time threshold. The predetermined transit time threshold may be a maximum duration of time for the second entity 19 to arrive at the first entity location. For example, a barber may allow a fifteen-minute transit time; therefore, the barber would only be included on the list of available entities if the transit time from a service user location to a barber location is within fifteen minutes.

In a preferred embodiment, the predetermined transit time threshold may be fifteen minutes for a barber or hairstylist. However, it should be understood that the predetermined transit time threshold could be one minute, two minutes, three minutes, four minutes, five minutes, ten minutes, twenty minutes, thirty minutes, forty-five minutes, one hour or longer. Similarly, in some embodiments, the predetermined transit time threshold could be less than one minute, less than two minutes, less than three minutes, less than four minutes, less than five minutes, less than ten minutes, less than twenty minutes, less than thirty minutes, less than forty-five minutes, or less than one hour. The predetermined transit time threshold may be different for different types of services/products. Additionally, the predetermined transit time threshold may change based on the time of day or the time of year. For example, a barber may have a ten-minute transit time threshold prior to an expected busy time of day, and may have a thirty-minute transit time threshold prior to a known slow time of day.

In one embodiment, the predetermined transit time threshold may differ between a particular first entity 17 and another first entity 17. In one embodiment, the first entity 17 may set the predetermined transit time threshold for itself. In one embodiment, the computer system 11 or a programmer of the computer system 11 may set the predetermined transit time threshold.

If the transit time between the second user computer device 22 and any of the plurality of first user computer devices 20 exceeds the predetermined transit time threshold, the associated first entity 17 will not be included in the list of available entities.

For brevity, the information regarding the available first entities 17 may be referred to as a list of available first entities 17 herein; however, it will be understood that the information may be provided in other forms, nonexclusive examples of which include a group, indicators on a map, and a holograph. In one embodiment, the information regarding the available first entities 17 is in the form of a list of available first entities 17 in order of descending transit times.

As shown in FIG. 2, in one embodiment, the computer-based matching method 200 may further comprise receiving a second request, by the computer system 11 from the second user computer device 22, indicative of the second entity 19 requesting one of the first entities 17 from the list of available first entities 17 (step 214); providing, with the computer system 11, the second request to one of the first user computer devices 20 associated with the requested one of the first entities 17 (step 216); receiving, by the computer system 11, a second-request response to the second request from the first user computer device 20 indicative of an acceptance or denial of the second request by the one of the first entities 17 (step 218); and providing the second-request response to the second user computer device 22 (step 220) for the second entity 19.

In one embodiment, optionally, the computer-based matching method 200 may further comprise providing location information associated with the second user computer device 22 (step 222) to the first user computer device 20 so that the first entity 17 may be able to track the progress of the second entity 19 in real time as the second entity 19 travels to the location of the first entity 17.

In one embodiment, optionally, the computer-based matching method 200 may further comprise storing the first request, the second request, and the second-request response on the one or more database 16 (step 224).

In use, in one embodiment, the computer-based matching method 200 enables the second user (the requester) to request the list of available entities (the service providers) within a predefined proximity based on transit time. The computer-based matching system 10 may receive the status of available service providers via the network 31 from the plurality of first user computer devices 20 and may store the status of available service providers in the one or more database 16. When the requester submits the first request, the one or more processor 12 may execute program logic stored on the one or more non-transitory computer-readable storage medium 14 to determine the transit time to each available service provider. The transit time to each available service provider may be received by the one or more processors 12 from one or more sources. The one or more processor 12 may generate the list of matching service providers that are available and within the predefined transit time threshold. The one or more processor 12 may provide the list of matching service providers to the second user computer device 22 via the network 31. The list of matching service providers may be in order of descending transit times from the location of the second user computer device 22 to the available service providers.

In another embodiment, the second user may be a buyer requesting a list of locations with an available product within a predefined proximity based on transit time. The one or more processor 12 may determine the transit time to each location with the matching product that are available and within the predefined transit time threshold. The computer-based matching system 10 may then provide a list of locations with the available product to the second user computer device 22 via the network 31. The list of locations with the available product may be in order of descending transit times from the location of the second user computer device 22 to the locations with the available product.

In use, in one embodiment, the first entity 17 may be a service provider and the second entity 19 may be a service user. In such an embodiment, the second request may refer to a request by the service user for a service to be performed by the service provider. The service provider may receive the second request via the first user computer device 20 and may provide the second-request response. The second-request response may be an acceptance or denial of the second request. If the service provider accepts the request to perform the requested service, then an appointment is established to begin at the end of the predetermined transit time threshold, and the service user is notified of the acceptance of the request. The service user is expected to arrive to the appointment within the predetermined transit time threshold. If the service provider denies the request, then the appointment will not be established, and the service user will be notified of the denial. The service user will then be able to submit another second request directed toward an alternative service provider from the list of available first entities 17, which may be repeated until one of the alternative service providers accepts the second request.

In one embodiment, the first entity 17 may be a product provider and the second entity 19 may be a product user. In such an embodiment, the second request may refer to the request by the product user for a product to be held by the product provider. The product provider may receive the second request via the first user computer device 20 and may provide the second-request response. The second-request response may be an acceptance or denial of the second request. If the product provider accepts the request for the product, then the product provider will hold the product for the product user for a period equal to the predetermined transit time threshold, and the product user will be notified of the acceptance of the request. The product user may then purchase the product within the determined transit time threshold. Conversely, if the product provider denies the second request, then the product provider does not hold the product for the product user, and the product user may be notified of the denial. The product user may then be able to submit another second request directed toward a different product provider from the list of available first entities 17, which may be repeated until a product provider accepts the second request.

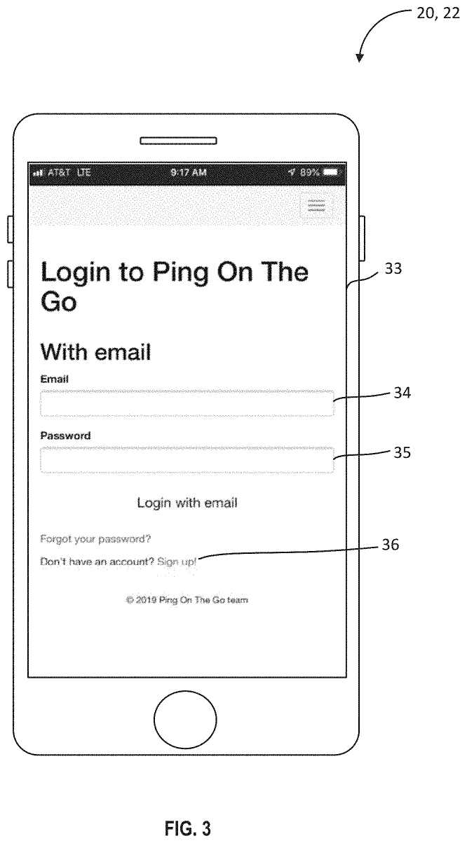

In use, in one embodiment, the first and/or second user computer device 20, 22 may be smartphones and the computer-based matching method 200 may be implemented as a software application run on the smartphones. For exemplary purposes, FIGS. 3-10 depict one exemplary such implementation, but it will be understood that the computer-based matching method 200 is not limited to such an implementation.

As depicted in FIG. 3, a login screen 33 may be displayed on the display 28 of the first and/or second user computer device 20, 22. The login screen 33 may require a user (such as the first entity 17 and the second entity 19) to input information in order to gain access to the computer-based matching system 10. In one embodiment, the required information may include a user name and/or a user password to be input by the user into a user field 34 and/or a password field 35 to allow the computer-based matching system 10 to distinguish between multiple users. The user name may be an email address, phone number, or any other set of characters that may be unique to a single user.

In the exemplary embodiment shown in FIG. 3, the user field 34 is associated with the user's email address. If the user has not previously established a user name and/or password, the user may be required to create a user account by making an input to generate the user account. In the exemplary embodiment shown in FIG. 3, a ‘Sign up’ link 36 is available to allow a new user to initiate the process of creating the user account. The user may be required to provide additional personal identifiable information when creating the user account. The personal identifiable information may include, but is not limited to, first and last name, phone number, email address, age, physical address, billing information, user name, password, photograph and the like. Once the user account has been created, the user may login by inputting the user name and password into the user field 34 and password field 35.

In another embodiment, the user may gain access to the computer-based matching system 10 by other means of authenticating a first or second user identity. The first or second user identity may be authenticated through voice recognition, facial recognition, fingerprint, or any other method of authentication. In another embodiment, only the first entity 17 is required to login to the computer-based matching system 10, while the second entity 19 is able to access the computer-based matching system 10 without logging in. Although the login screen 33 is currently depicted as having the same screen for the first and second user computer devices 20, 22, it should be understood that the login screens 33 may be different for different users.

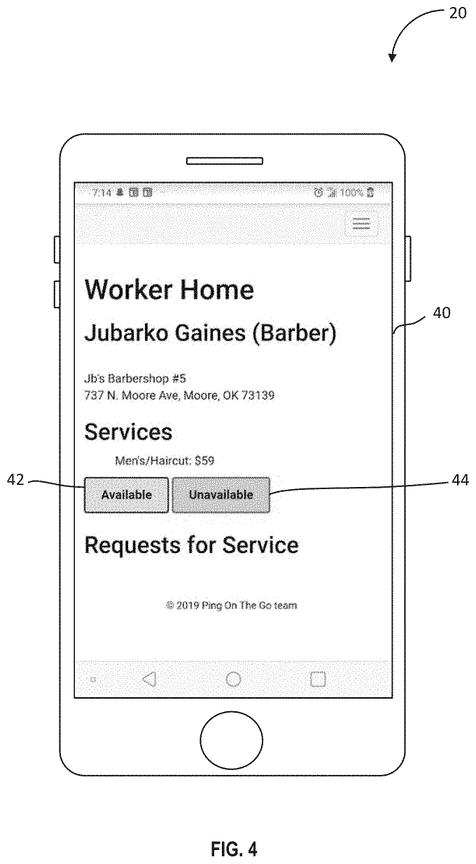

In one embodiment, as shown in FIG. 4, after the first entity 17 logs into the computer-based matching system 10, the first user computer device 20 may display a status of availability screen 40 in which the first entity 17 is able to selectively input its status of availability. Options regarding the status of availability may be indicative of whether the associated first entity 17 is presently available at the time the status of availability selection is made. If there is more than one first entity 17 associated with the account, the first entity 17 may be required to first select one or more associated first entity(ies) 17 before selecting the status of availability to be associated with the one or more first entity(ies) 17.

In the exemplary embodiment depicted in FIG. 4, the options for indicating the status of availability includes the “Available” indication 42 or “Unavailable” indication 44; however, it should be understood that other indications of the status of availability may be used. Nonexclusive examples of inputting the status of availability include utilizing one or more icon(s) that may be enlarged, highlighted, or change colors when the one or more icon(s) is selected to indicate the status of availability of the entity; and one or more checkbox located next to the status of availability which indicate the status of availability for the associated first entity 17 when the box is checked. The status of availability of the associated entity within the computer-based matching system 10 may be updated in real-time as the status of availability is changed on the first user computer device 20.

In one embodiment, there may be an option to schedule the status of availability over an extended period of time. A first entity 17 may use a calendar feature to select a date and time in which the first entity 17 is available, and the date and time in which the first entity 17 is not available. The first entity 17 may be able to alter the date and time as the status of availability changes overtime. For instance, if the first entity 17 had previously listed the status of availability as available, but the first entity 17 became unexpectedly unavailable, then the first entity 17 would be able to selectively update the status of availability to reflect the change in the availability of the first entity 17.

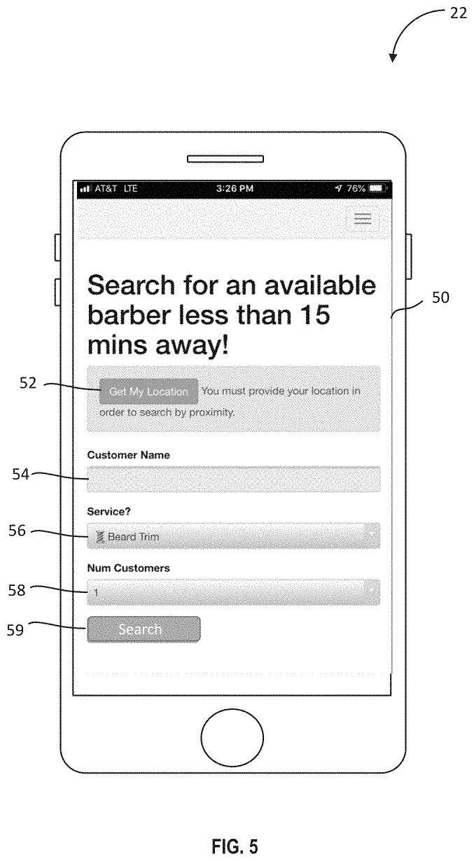

FIG. 5 depicts an exemplary selection page 50 that may be displayed on the display 28 of the second user computer device 22 for selecting and sending the first request for the list of available first entities 17. In one embodiment, the selection page 50 may include a second entity location field 52 in which the second entity 19 may input location data indicative of a present location of the second entity 19. In one embodiment, the location data can be procured programmatically and automatically from the second user computer device 22 when the computer-based matching system 10 is in use, for example, based on GPS information from the positioning device 23 of the second user computer device 22. In the exemplary embodiment shown in FIG. 5, a box labeled “Get My Location” may allow the computer-based matching system 10 to obtain the location information from the positioning device 23 of the second user computer device 22 when the second entity 19 makes an input indicative of selecting the box. The location data may be in the form of a physical address, longitudinal/latitudinal coordinates, GPS coordinates, or any other format capable of accurately describing the present second entity location.

In one embodiment, the selection page 50 may include a user name field 54. The second entity 19 may input a name to identify the second entity 19 in the user name field 54. The name may a legal name, a nickname, or a name generated by the computer-based matching system 10 to identify and distinguish the second entity 19 from other users. If the second entity 19 had already logged into the user account, the user name field 54 may be populated from the personal identifiable information associated with the user account, which may be saved in the one or more database 16 or in the second user computer device 22.

In one embodiment, the selection page 50 may include one or more search criteria field 56. The one or more search criteria field(s) 56 may identify desired characteristic(s) of the available first entities 17. The desired characteristics may include the general type of entity (service or product), specific types of entities available, cost, location, skill-level, certifications, customer ratings, specific services available, specific products available, type of business, business name, or other characteristics. For example, the second entity 19 may select the one or more fields to indicate the desired characteristics include available barbers located at JB's Barber shop that will perform a men's hair cut for a moderate price. In the exemplary embodiment shown in FIG. 5, the search criteria field 56 includes a dropdown menu that provides various types of services that may be selectively chosen.

In another embodiment, the second entity 19 may be presented with a plurality of selection pages 50 that allow the second entity 19 to identify and progressively narrow the desired characteristics for the list of available first entities 17. For example, a first selection page 50 may only contain an option to select either a service or a product, the next selection page 50 may then provide the option to select a more narrowed desired characteristic based on the previous selection, and so on.

In one embodiment, a number-of-customers field 58 may be available on the selection page 50 that enable the second entity 19 to selectively indicate the number of customers associated with the first request. For example, if the second entity 19 represents three men needing to get a beard trim, the second entity 19 would selectively indicate three customers in the number of customers field 58. In FIG. 5, the number-of-customers field 58 is depicted as a dropdown menu; however, it should be understood that other methods of inputting the number of customers may be possible.

In one embodiment, a first request submission field 59 may be available on the selection page 50 that enables the second entity 19 to transmit the selected desired characteristics from the second user computer device 22 to the one or more processor 12 via the network 31. The computer-based matching system 10 may require all fields on the selection page 50 to be completed before enabling the first request submission field 59 to transmit the first request. The first request submission field 59 is displayed in FIG. 5 as a box labeled “Search.”

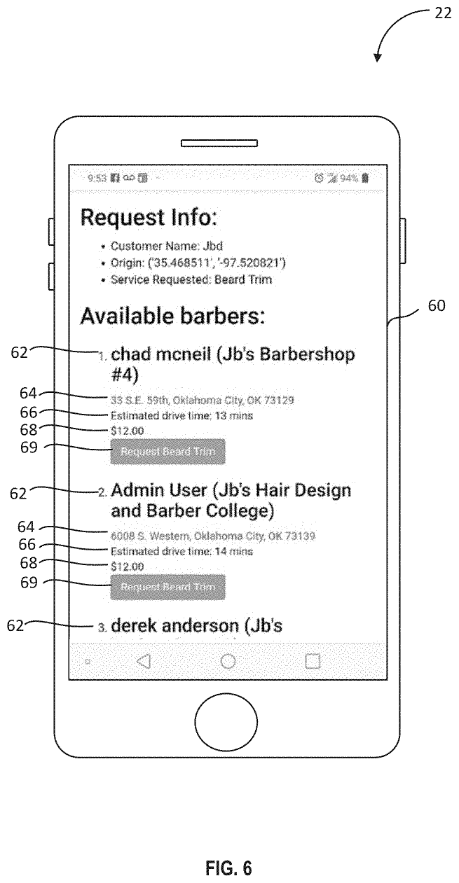

FIG. 6 depicts an exemplary screenshot of a list of available entities page 60 that may be displayed on the display 28 of the second user computer device 22. The one or more processor 12 may generate the list of available first entities 17 after receiving the first request from the second user computer device 22 and then may transmit the list of available first entities 17 to the second user computer device 22 via the network 31 (and/or may transmit the list of available first entries 17 directly). The list of available first entities 17 may be based on the status of availability of the first entities 17 received from the first user computer device 20, the calculated transit time between the second entity 19 and each first entity 17, and the selected desired characteristics. An available first entity 17 may be included on the list of available first entities 17 if the calculated transit time between the second entity 19 and the first entity 17 is below predetermined transit time threshold.

In one embodiment, the list of available first entities 17 may be displayed on the display 28 in a data grid format on the second user computer device 22. The list of available first entities 17 may be sorted in order of descending transit times from the current second entity location to the first entity location(s). In one embodiment, the list of available first entities 17 may also include additional information associated with each available first entity 17. For example, as shown in FIG. 6, the list of available entities page 60 showing the list of available first entities 17 includes an entity title 62, an entity address 64, a calculated transit time 66, and a price 68 for a service/or product requested by the second entity 19. Additional information may include one or more of imagery, phone numbers, services provided, customer rankings, skill levels, and other pertinent information. In one embodiment, the additional information may be accessible by the second entity 19 providing an input indicative of requesting the additional information fora specific first entity 17. For example, the second entity 19 may request additional information about the specific first entity 17 by clicking on the entity title 62 which brings up a new page, or new window, that contains the additional information with respect to the selected first entity 17.

In one embodiment, the list of available entities page 60 may include a second request field 69. The second request field 69 may be used to generate and transmit a second request from the second entity computer device 22 to the one or more processors 12 via the network 31. The second request field 69, as depicted in FIG. 6, is represented by a box that is labeled “Request Beard Trim.” In another embodiment, the second request field 69 may only be available after the second user has provided an input requesting the additional information as discussed above.

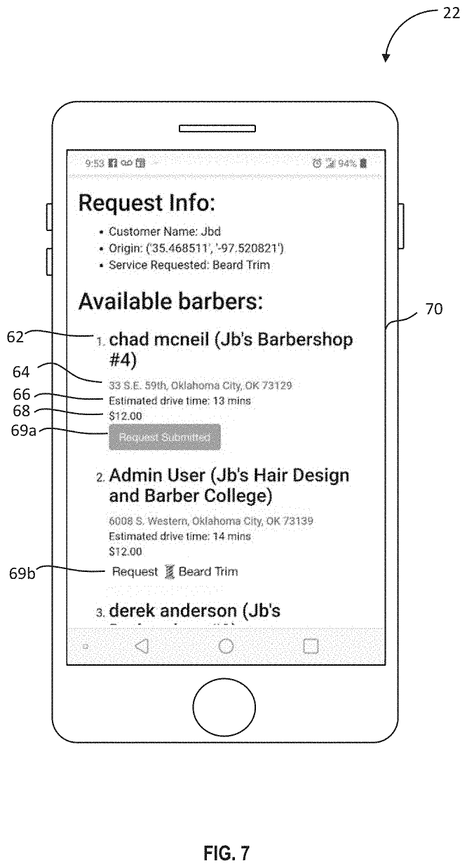

An exemplary screenshot on the display 28 of the second user computer device 22 depicts a second-request submission page 70 for selecting a desired first entity 17 and transmitting a second request for a selected first entity 17 is shown in FIG. 7. The second request may comprise a request for an engagement between the selected first entity 17 and the second entity 19 to start no later than the end of the predetermined transit time threshold. In one embodiment, the second entity 19 may provide an input indicative of selecting the selected first entity 17 and then provide an input indicative of transmitting the second request. For example, the second entity 19 may use a checkbox collocated with the entity title 62, and then click on the second request field 69 to cause the transmission of the request for the engagement with the selected first entity 17 identified by the checked box. In another embodiment, a single input by the second entity 19 may be used to select the desired first entity 17 and cause the transmission of the second request. For instance, in FIG. 6, each listed first entity 17 has an associated second request field 69 that when selected by the second entity 19 causes the transmission of the second request.

After the second request has been transmitted from the second user computer device 22, the second entity 19 may be provided with additional information associated with the selected first entity 17 that may not have been available prior to selecting and transmitting the second request. For instance, the address associated with the selected first entity 17 may not be viewable by the second entity 19 until the second request has been selected and transmitted. Additionally, as shown in FIG. 7, the second user computer device 22 may display a second request status field 69a to provide an indication of a status of the second request. The second request status field 69a may be an icon, a color, a text box, or any other indication capable of conveying the status of the second request. A non-exclusive list of possible statuses regarding the second request might include a status to indicate the second request was submitted, the second request was denied, the second request was accepted, the second request was canceled, or the second request was completed. In FIG. 7, the second request status field 69a is a text box labeled “Request Submitted” with an orange background that has replaced the second request field 69.

In some embodiments, once the second request has been transmitted and while the second request is pending a response from the first user, the second user may be precluded from transmitting additional second request. In FIG. 7, the second request field 69b associated with the second entity 19, “Admin User,” is no longer a button icon to indicate that the second request field 69b is inaccessible to receive an input from the second entity 19. Thereafter, if the second request is denied or canceled, the second request status field 69a will be updated to reflect that the second request was denied or canceled, and the second entity 19 may be able submit additional second request. Alternatively, if the second request is accepted, the second request status field 69a will be updated to reflect that the second request was accepted, but the second entity 19 may not be able to submit additional second request until the engagement is completed or canceled.

The computer system 11 may receive the second request from the second user computer device 22 that comprises the request for an engagement with the selected first entity 17 associated with the first user computer device 20. The computer system 11 then transmits the second request to the first user computer device 20 that is associated with the selected first entity 17. The first user computer device 20 may notify the first entity 17 of the transmission of the second request by way of a push notification, an email, a text message, or phone call. The notification of the first user computer device 20 may provide the first entity 17 with an option to accept or deny the second request. The second request may include additional information related to the second entity 19 to assist the first user in determining whether to accept or deny the second request. The additional information may comprise one or more of the following: the profile of the second entity 19; the calculated transit time; the current second entity location of the second entity 19; previous interactions between the first entity 17 and the second entity 19; a rating of the second entity 19; and other pertinent information.

If the first entity 17 accepts the second request, the status of availability for the selected first entity 17 changes from “available” to “unavailable,” for the first entity 17 to fulfill the second request. For example, a service provider such as a barber that accepts a request for a haircut will have his status of availability changed to “unavailable” and the barber will provide a haircut to the service requester upon his arrival to the barbershop.

Additionally, the first entity 17 may be able track the second user computer device 22 as the second entity 19 progresses toward the location of the first entity 17. The location of the second entity 19 may be automatically updated based on positioning device 23 of the second user computer device 22 and periodically provided to the first entity 17 in real time.

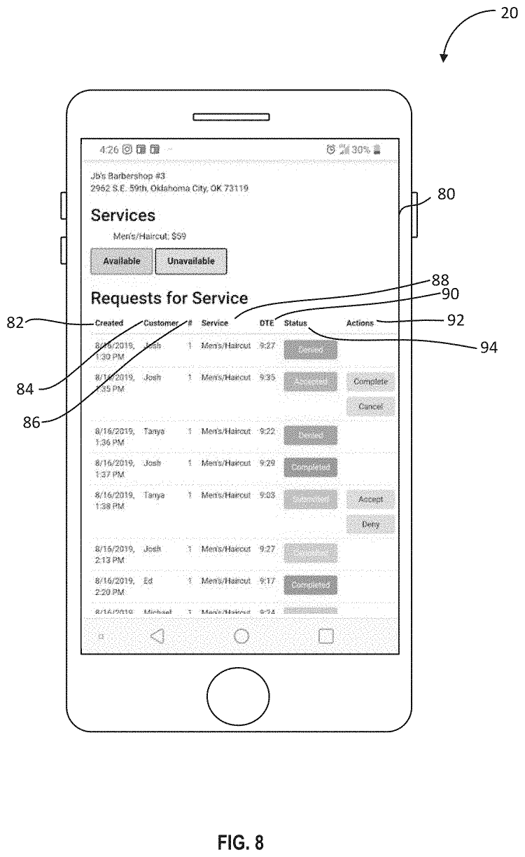

Now referencing FIG. 8, an exemplary screenshot is shown relating to a first user request status page 80 that may be displayed on the display 28 of the first user computer device 20. The first user request status page 80 may include additional information related to the second request received from one or more second entities 19. The additional information may include one or more of the following: time data 82, second user name data 84, number of customers data 86, requested entity data 88, distance time estimate data 90, and second-request status data 92.

The time data 82 may include a time stamp related to the time the second request was transmitted from the second user computer device 22 or the time the second request was received by the first user computer device 20. The time data 82 may be formatted to includes one or more of the following: day, month, year, hour, minutes, and seconds.

The second user name data 84 may be any set of characters used to identify the second entity 19 associated with the second request and allow the first entity 17 to distinguish between multiple second request by the identity of the second entity 19. In some embodiments, the second user name data 84 may comprise the user name the second entity 19 used to log into the computer-based matching system 10, the name provided in the user account, or the name input into the a user name field 54.

The number of customers data 86 may comprise the number of customers provided in the number of customers field 58 that was submitted with the first request.

The requested entity data 88 may comprise a title or description of the specific service or product that the second entity 19 requested the engagement with in the second request.

The distance time estimate data 90 comprises an estimation of a transit time based on the distance between the location of the first entity 17 and the second entity location. The distance time estimate data 90 may take into consideration a number of factors, such as, modality of travel, route of travel, local traffic laws, road conditions, environmental conditions, time of day, historical traffic data, real-time traffic reports, and any other variable that may affect the transit time. In one embodiment, the distance time estimate data 90 is determined either at the time the second request is transmitted from the second entity 19 or at the time the second request is received by the first entity 17. In another embodiment, the distance time estimate data 90 may be updated periodically to reflect changes to the factors considered during the estimation. For example, as the second entity 19 becomes closer and closer to the first entity 17 the distance time estimate data 90 would indicate a shorter and shorter transit time. However, if the second entity 19 encountered an unexpected traffic delay the distance time estimate data 90 may be updated to indicate a longer transit time.

The second request status data 92 may comprise the current status of the second request. The second request status data 92 may be conveyed by an icon, a color, a text box, or any other indication capable of conveying the status of the second request. A non-exclusive list of possible statuses regarding the second request might include a status to indicate the second request was submitted, the second request was denied, the second request was accepted, the second request was canceled, or the second request was completed.

In one embodiment, the first user request status page 80 may only include the additional data associated with a single second request. In another embodiment, the first user request status page 80 may include the additional information from more than one second requests from more than one second users. In FIG. 8, the first user request status page 80 comprises a table with each row representing an individual second request arranged by date and time received and the columns providing the additional information described above.

The first user request status page 80 may also include an action field 94 that allows the first user to selectively modify the status of the second request. A non-exclusive list of actions that may be included within the action field 94 comprises accept, deny, complete, or cancel the second request. For example, in FIG. 8, the action field 94 includes a “Complete” button and a “Cancel” button next to the “Accepted” status of the second request, and an “Accept” button and a “Deny” button next to the “Submitted” status of the second request. When the first entity 17 provides an input indicative of modifying the status of the second request, the first user computer device 20 may transmit the changed status to the computer system 11 and then to the second user computer device 22 in real time.

In one embodiment, the first user request status page 80 may be updated to remove the additional information related to the second request after a predetermined period of time. For instance, if the status of a particular second request has not been modified in the more than one hour, the additional information related to that second request may be removed. In another embodiment, the first user request status page 80 may be reset on a daily basis, in which all additional information related to all second request is removed from the first user request status page 80. In yet another embodiment, the first entity 17 may be required to provide an input for removal of the additional information related to the second request(s).

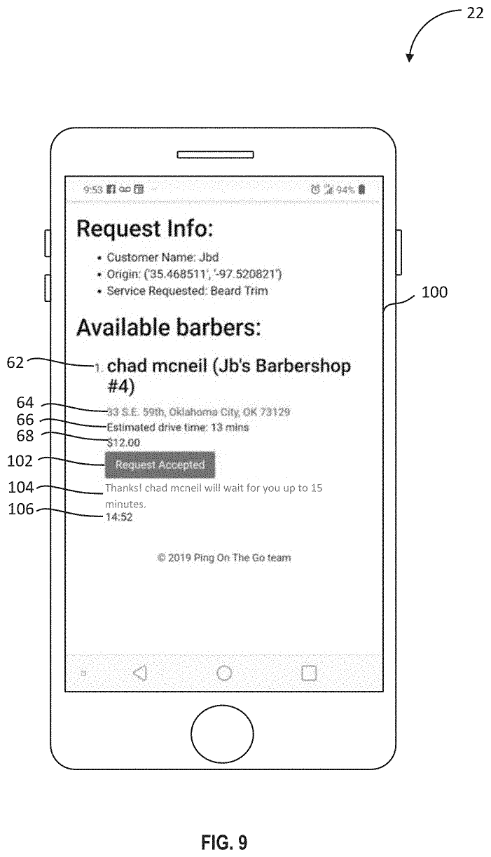

FIG. 9 is an exemplary screenshot of a display on the second user computer device 22, the screenshot depicts a second-request response page 100 relating to the response of the first entity 17 with respect to the second request. The response of the first entity 17 to the second request is transmitted to the one or more processor 12 and then to the second user computer device 22 via the network 31. In one embodiment, the second-request response page 100 may include a response status field 102 that provides an indication of the response of the first entity 17 to the second request. The response status field 102 may include an indication that the first entity 17 has accepted, denied, completed, or canceled the second request. If the first entity 17 accepts the second request, an appointment is established to begin within or at the end of the predetermined transit time threshold. If the first entity 17 denies or cancels the second request, the second entity 19 may be instructed to conduct a new first request, or to select another first entity 17 from the list of available first entities 17 from the previous first request. In some embodiments, an updated list of available first entities 17 may be automatically generated and transmitted to the second user computer device 22 if the second request is denied or canceled. The updated list of available first entities 17 would not include the previously selected first entity 17 that denied the second request.

In one embodiment, the second-request response page 100 may include additional information to provide the second entity 19 with relevant information regarding the engagement with the selected first entity 17. For example, as shown in FIG. 9, the second-request response page 100 may include the entity title 62, the entity address 64, the calculated transit time 66, the price 68, a personalized message 104, and a countdown clock 106. The countdown clock 106 may be based on the predetermined transit time threshold and/or the determined transit time. The countdown clock 106 may initiate a countdown from the time the second request is accepted until the second user arrives at the first user's location or the time expires. If the second entity 19 fails to arrive to the first entity location within the permitted time, the appointment between the second entity 19 and the selected first entity 17 may be terminated.

The second user computer device 22 may notify the second entity 19 of the reception of the response to the second request and/or direct the second entity 19 to the second-request response page 100 by way of, for example, a push notification, an email, a text message, or a phone call.

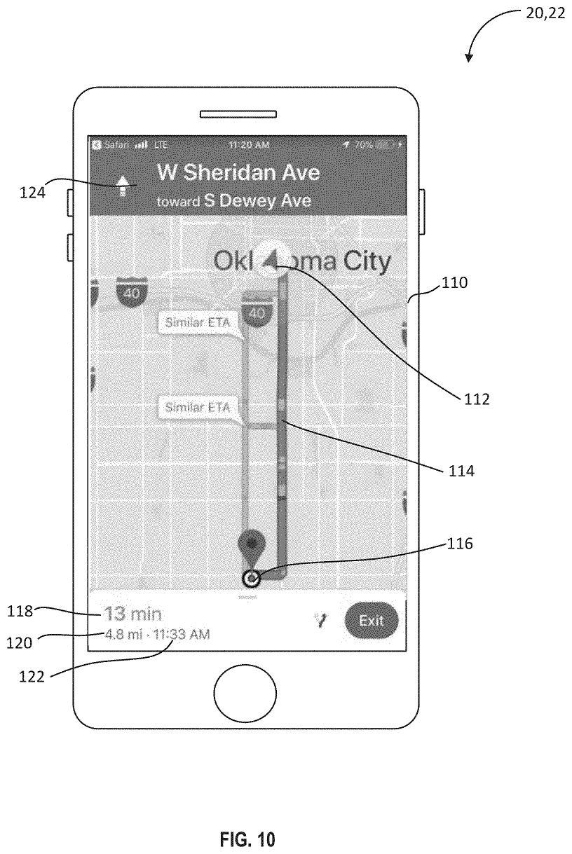

In FIG. 10, an exemplary screenshot is shown relating to a geographical location page 110 that may be displayed on the display 28 of the first or second user computer device 20, 22. After the second request has been accepted, the first and second users may be provided with access to the geographical location page 110, which displays a visual representation of a route of travel between the second entity 19 and the first entity 17 and may include information relating to transit time between the second entity location and the first entity location.

In one embodiment, the geographical location page 110 may include a second user icon 112, a route of travel 114, a first user icon 116, an estimated time of travel 118, a distance indication 120, an estimated time of arrival 122, and an instruction of travel 130. The second user icon 112, the route of travel 114 and the first user icon 116 may be overlaid a map image of a geographical area that includes the first entity location and the second entity location. The geographical location page 110 may be updated in real-time to reflect changes in the location of the second user computer device 22, as well as the transit time information. For example, as the second user is in transit toward the first user, the position of the second user, depicted as the second user icon 112, will be updated in real time. Additionally, the estimated time of travel 118 and the distance indication 120 may continue to decrease as the second entity 19 transits closer and closer to the first entity location. In some embodiments, the instruction of travel 130 may provide turn-by-turn instructions based on the route of travel 114. Although the geographical location page 110 is depicted in FIG. 10 as the same screen for the first and second user computer device 20, 22, it should be understood that the visual representation and transit time information may be displayed differently between the first and second user computer devices 20, 22.

In some embodiments, the computer-based matching system 10 may utilize existing web mapping services, such as Apple Maps, Google Maps, or Bing Maps to generate at least some portion of the geographical location page 110.

Further non-exclusive examples of the computer-based matching system 10 in use will now be described. In one embodiment, in use, a plurality of first entities 17 and second entities 19 may download a software application to the plurality of first user computer devices 20 and the plurality of second user computer devices 22 that are connected to the computer system 11, such as via the network 31 or directly.

A first entity 17, in this case a service-provider, may create a user profile that includes one or more of the following characteristics associated with the service provider: the service provider's location, the types of services performed, the cost of the services, the skill-level of the service provider, the qualifications of the service provider, and photographic examples of provided services. The service provider may select a status of availability with respect to the ability to provide immediate services.

For example, a barber may download and install the software application onto a tablet that is used at the barbershop. The barber may then create a user profile that includes the barbershop's address as the service provider's location, the list of hairstyles the barber will perform and associated fee, and photos from previous haircuts. If the barber does not have any immediate appointments scheduled and there is no one waiting for a haircut, the barber may select that he is available to perform an immediate haircut.

A second entity 19, in this case a service user, may also create a user profile that enables the computer-based matching system 10 to distinguish between different service users and includes personal identifiable information. The service user may be able to submit a request for a list of available service providers within a predetermined proximity based on transit time to be generated by the computer-based matching system 10. The request may comprise desirable characteristics associated with the service providers and/or the services to be performed.

For example, a service user needing a haircut may submit a request for a list of barbers that are immediately available to provide a men's haircut and a shave within a fifteen-minute transit time. The request is transmitted to the computers system 11, for example, via the network 31. Upon receiving the request, the one or more processor 12 may determine all available barbers, based on the status of availability submitted by a plurality of service users, that are able to perform the desired services and are also within the fifteen-minute transit time. The service user needing the haircut may receive the list of available barbers after submitting the request. The service user may be able to receive additional information associated with individual barbers from the list of available barbers by clicking on a particular barber of interest. The service user may be able to request an immediate appointment with one of the barbers from the list of available barbers. An icon or button may be available to allow the person to make the request for the immediate appointment.

When the service user requests the appointment with one of the barbers from the list, the computer-based matching system 10 may send the request to the requested barber. The requested barber may be presented with a notification of the request for the immediate appointment and is able to decide whether to accept or deny the request. If the requested barber accepts the request for the immediate appointment, the barber will know that the person should arrive within the predetermined transit time threshold for the barber to provide his services. The service user will know that upon his arrival to the barbershop, the barber with a desired skillset will be waiting to provide the requested services.

In one exemplary use, the person may need the services of a car mechanic to service the person's automobile. The person may submit a request for a list of available mechanics that change oil and rotate tires. In this case, the predetermined time transit threshold may be thirty minutes from the original location of the service user. The computer system 11 may then provide the service user with a list of available mechanics reachable within a thirty minutes transit-time. The service user may request an appointment with one of the mechanics from the list of available mechanics, the appointment to begin no later than the thirty-minute predetermined time transit threshold. If the requested mechanic accepts the request for the immediate appointment, the requested mechanic should be available to service the person vehicle when the person arrives to the mechanic's shop.

In another yet example, the second entity 19 may be a product user and may be requesting a particular product to be held for pickup instead of a service to be provided. A plurality of merchants may capture a plurality of products with an associated status of availability within the one or more database 16 of the computer system 11. The product user may submit a request for a list of available products. In this case, the predetermined time transit threshold may be ten minutes. The processor 12 may then generate the list of available products based on the status of availability provided by the merchants. The product user may request the product be held by the merchant until the product user can pick up the product. If the merchant accepts the request, the merchant agrees to hold the product for the product user through the predetermined transit time threshold.

### CONCLUSION

Conventionally, a person wanting to receive a service from a service provider would either schedule an advance appointment with the service provider, or the person would need to make themselves available to the service provider and wait until the service provider was available to perform the service. The present invention allows the person to receive a list of all service providers that are immediately available within a predetermined proximity based on transit time. Additionally, the person is then able to establish an immediate request for services to be performed by at least one of the service providers from the received list, while the service provider can fill open service times without the uncertainty of traditional “walk-in” appointments.

The foregoing description provides illustration and description, but is not intended to be exhaustive or to limit the inventive concepts to the precise form disclosed. Modifications and variations are possible in light of the above teachings or may be acquired from practice of the methodologies set forth in the present disclosure.

Even though particular combinations of features are recited in the claims and/or disclosed in the specification, these combinations are not intended to limit the disclosure. In fact, many of these features may be combined in ways not specifically recited in the claims and/or disclosed in the specification. Although each dependent claim listed below may directly depend on only one other claim, the disclosure includes each dependent claim in combination with every other claim in the claim set.

No element, act, or instruction used in the present application should be construed as critical or essential to the invention unless explicitly described as such outside of the preferred embodiment. Further, the phrase “based on” is intended to mean “based, at least in part, on” unless explicitly stated otherwise.

What is claimed is:

1. A computer-based system for matching geographically separated entities, comprising:
one or more computer processor; and
one or more non-transitory computer readable medium storing computer executable code that when executed by the one or more computer processor cause the one or more computer processor to:
receive, from one or more service-provider computer device, an availability status of a plurality of service providers, the availability status consisting of one of available and unavailable;
receive, from a requester smartphone, a query from a service user comprising a request for available service providers having an availability status of available, wherein the query is accompanied by current location data associated with the requester smartphone;
determine transit time between the service user and each available service provider based on the current location data associated with the requester smartphone, location data associated with each service provider, and mapping information;
determine one or more matching service provider from the plurality of available service providers, based at least on the determined transit time between the service user and each service provider being a shorter duration than a predetermined-transit-time threshold from a current time of the query, wherein the predetermined-transit-time threshold is a maximum duration of time allowed for the service user to arrive at a location of the matching service provider;
provide, to the requester smartphone, the matching service providers;
receive, from the requester smartphone, an appointment request for an appointment for the service user with a selected service provider out of the matching service providers;
provide, to the one or more service-provider computer device of the selected service provider, the appointment request;
receive, from the one or more service-provider computer device of the selected service provider, an acceptance of the appointment request; and
provide, to the requester smartphone, the acceptance of the appointment request.

2. The computer-based system of claim 1, wherein the computer executable code that when executed by the one or more computer processor further causes the one or more computer processor to:
begin a countdown of time at the predetermined-transit-time threshold; and
provide the countdown of time at the predetermined-transit-time threshold to at least one of the service user and the selected service provider.

3. The computer-based system of claim 1, wherein the computer executable code that when executed by the one or more computer processor further causes the one or more computer processor to store, on the one or more non-transitory computer readable medium, a record of the appointment request and the acceptance of the appointment request.

4. The computer-based system of claim 1, wherein the computer executable code that when executed by the one or more computer processor further causes the one or more computer processor to:
receive, from the one or more service-provider computer device, information indicative of characteristics of the one or more service provider;
wherein the query from the service user further comprises one or more desired characteristics of the available service providers; and
wherein determining one or more matching service provider from the plurality of available service providers, is further based on the desired characteristics matching the received characteristics.

5. The computer-based system of claim 4, wherein the desired characteristics comprise one or more of cost, location, skill level, certifications, customer ratings, business name, type of business, and services available.

6. The computer-based system of claim 1, wherein the computer executable code that when executed by the one or more computer processor further causes the one or more computer processor to:
provide, to the service-provider computer device of the selected service provider, information indicative of movement of the service user in real time as the service user travels to the selected service provider based on the location data associated with the requester smartphone and the location data associated with the selected service provider.

7. The computer-based system of claim 1, wherein determining transit time between the service user and each available service provider is further based on modality of travel of the service user.

8. The computer-based system of claim 1, wherein determining transit time between the service user and each available service provider is further based on one or more of a route of travel of the service user, local traffic laws, road conditions, environmental conditions, time of day, historical traffic data, and traffic reports.

9. The computer-based system of claim 1, wherein the computer executable code that when executed by the one or more computer processor causing the one or more computer processor to determine transit time between the service user and each available service provider further comprises causing the one or more computer processor to receive the transit time or to calculate the transit time.

10. A computer-based system for matching geographically separated entities, comprising:
one or more computer processor; and
one or more non-transitory computer readable medium storing computer executable code that when executed by the one or more computer processor cause the one or more computer processor to:
receive, from one or more product-provider computer device, an availability status of a plurality of product providers, the availability status consisting of one of available and unavailable;
receive, from a requester smartphone, a query from a product user comprising a request for available product providers, wherein the query is accompanied by current location data associated with the requester smartphone, and wherein available product providers have an availability status of available;
determine transit time between the product user and each available product provider based on the current location data associated with the requester smartphone, location data associated with each product provider, and mapping information;
determine one or more matching product provider from the plurality of available product providers, based at least on the determined transit time between the product user and each product provider being within a predetermined-transit-time threshold from a current time of the query, wherein the predetermined-transit-time threshold is a maximum duration of time allowed for the product user to arrive at a location of the matching product provider;
provide, to the requester smartphone, the matching product providers;
receive, from the requester smartphone, an appointment request for an appointment for the product user with a selected product provider out of the matching product providers;
provide, to the one or more product-provider computer device of the selected product provider, the appointment request;
receive, from the one or more product-provider computer device of the selected product provider, an acceptance of the appointment request; and
provide, to the requester smartphone, the acceptance of the appointment request.

11. The computer-based system of claim 10, wherein the computer executable code that when executed by the one or more computer processor further causes the one or more computer processor to:
receive, from the one or more product-provider computer device, information indicative of characteristics of a plurality of products and the one or more product provider;
wherein the query from the product user further comprises one or more desired characteristics of the plurality of products and the available product providers; and
wherein determining one or more matching product provider from the plurality of available product providers, is further based on the desired characteristics matching the received characteristics.
wherein the desired characteristics comprise one or more of cost, location, quality, brand, size of product, business name, type of business, and products available.

12. A computer-based method for matching geographically separated entities, comprising:
receiving, with one or more computer processor from one or more service-provider computer device, an availability status of a plurality of service providers, the availability status consisting of one of available and unavailable;
receiving, with the one or more computer processor from a requester smartphone, a query from a service user comprising a request for available service providers have an availability status of available, wherein the query is accompanied by current location data associated with the requester smartphone;
determining, with the one or more computer processor, a transit time between the service user and each available service provider based on the current location data associated with the requester smartphone, location data associated with each service provider, and mapping information;
determining, with the one or more computer processor, one or more matching service provider from the plurality of available service providers, based at least on the determined transit time between the service user and each available service provider being a shorter duration than a predetermined-transit-time threshold from a current time of the query, wherein the predetermined-transit-time threshold is a maximum duration of time allowed for the service user to arrive at a location of the matching service provider;
providing, with the one or more computer processor to the requester smartphone, the matching service providers;
receiving, with the one or more computer processor from the requester smartphone, an appointment request for an appointment for the service user with a selected service provider out of the matching service providers;
providing, with the one or more computer processor to the one or more service-provider computer device of the selected service provider, the appointment request;
receiving, with the one or more computer processor from the one or more service-provider computer device of the selected service provider, an acceptance of the appointment request; and
providing, with the one or more computer processor to the requester smartphone, the acceptance of the appointment request.

13. The computer-based method of claim 12, wherein the method further comprises:
generating, with the one or more processor, a countdown of time beginning at the predetermined-transit-time threshold; and
providing, with the one or more computer processor, the countdown of time beginning at the predetermined-transit-time threshold to at least one of the service user and the selected service provider.

14. The computer-based method of claim 12, wherein the method further comprises:
storing, on one or more non-transitory computer readable medium, a record of the appointment request and the acceptance of the appointment request.

15. The computer-based method of claim 12, wherein the method further comprises:
receiving, with the one or more computer processor from the one or more service-provider computer device, information indicative of characteristics of the one or more service provider;
wherein the query from the service user further comprises one or more desired characteristics of the available service providers; and
wherein determining one or more matching service provider from the plurality of available service providers, is further based on the desired characteristics matching the received characteristics.

16. The computer-based method of claim 15, wherein the desired characteristics comprise one or more of cost, location, skill level, certifications, customer ratings, business name, type of business, and services available.

17. The computer-based method of claim 12, wherein the method further comprises:
providing, with the one or more computer processor to the service-provider computer device of the selected service provider, information indicative of movement of the service user in real time as the service user travels to the selected service provider based on the location data associated with the requester smartphone and the location data associated with the selected service provider.

18. The computer-based method of claim 12, wherein determining transit time between the service user and each available service provider is further based on modality of travel of the service user.

19. The computer-based method of claim 12, wherein determining transit time between the service user and each available service provider is further based on one or more of a route of travel of the service user, local traffic laws, road conditions, environmental conditions, time of day, historical traffic data, and traffic reports.

20. The computer-based method of claim 12, wherein determining with the one or more computer processor a transit time between the service user and each available service provider further comprises receiving the transit time or calculating the transit time.
